(19) United States
(12) Patent Application Publication
(10) Pub. No.: US 2020/0070581 A1
(43) Pub. Date: Mar. 5, 2020

(54) HOOPING REINFORCEMENT FOR A TIRE OF A HEAVY DUTY CIVIL ENGINEERING VEHICLE

(71) Applicant: COMPAGNIE GENERALE DES ETABLISSEMENTS MICHELIN, CLERMONT-FERRAND (FR)

(72) Inventors: Alain DOMINGO, CLERMONT-FERRAND (FR); Elodie LE CHENADEC, CLERMONT-FERRAND (FR)

(21) Appl. No.: 16/462,824

(22) PCT Filed: Nov. 9, 2017
(86) PCT No.: PCT/FR2017/053055

§ 371 Date: May 21, 2019

(30) Foreign Application Priority Data
Nov. 21, 2016 (FR) 1661290

(51) Int. Cl. B60C 9/00; B60C 9/18

(52) U.S. Cl. CPC B60C 9/0007; B60C 2200/065; B60C 9/18

(57) ABSTRACT

A hoop reinforcement is provided for a tire for a heavy vehicle of construction plant type. The crown reinforcement (3) of the tire (1), radially on the inside of a tread (2), comprises a protective reinforcement (6), a working reinforcement (5) and a hoop reinforcement (7). The hoop reinforcement (7) is formed by a circumferential winding, in the circumferential direction (XX′), of a ply of metallic reinforcers (8) forming an angle at most equal to 2.5° with the circumferential direction (XX′), extending from an initial radially inner end (81) to a final radially outer end (82), forming a spiral, such that the hoop reinforcement (7) comprises at least two hooping layers (71, 72) around the entire circumference and at least three hooping layers (71, 72, 73) over an angular sector A, delimited by the initial and final ends (81, 82), respectively, of the hoop reinforcement (7). The hoop reinforcement (7) comprises at least one discontinuity (9) positioned circumferentially between the initial end (81) and final end (82), respectively, and any discontinuity (9) is positioned circumferentially, with respect to the initial or final end (81, 82), forming an angle (B1, B2) at least equal to 90°.

The subject of the present invention is a radial tyre, intended to be fitted to a heavy vehicle of construction plant type, and the invention relates more particularly to the crown reinforcement of such a tyre.

Typically, a radial tyre for a heavy vehicle of construction plant type, within the meaning of the European Tyre and Rim Technical Organisation or ETRTO standard, is intended to be mounted on a rim with a diameter at least equal to 25 inches. Although not limited to this type of application, the invention is described for a radial tyre of large size, intended to be mounted on a dumper, a vehicle for transporting materials extracted from quarries or open-cast mines, by way of a rim with a diameter at least equal to 49 inches, possibly as much as 57 inches, or even 63 inches.

Since a tyre has a geometry that exhibits symmetry of revolution about an axis of rotation, the geometry of the tyre is generally described in a meridian plane containing the axis of rotation of the tyre. For a given meridian plane, the radial, axial and circumferential directions denote the directions perpendicular to the axis of rotation of the tyre, parallel to the axis of rotation of the tyre and perpendicular to the meridian plane, respectively. The circumferential direction is tangential to the circumference of the tyre.

In the following text, the expressions “radially inner” and “radially outer” mean “closer to” and “further away from the axis of rotation of the tyre”, respectively. “Axially inside” and “axially outside” mean “closer to” and “further away from the equatorial plane of the tyre”, respectively, the equatorial plane of the tyre being the plane passing through the middle of the tread surface and perpendicular to the axis of rotation.

Generally, a tyre comprises a tread intended to come into contact with the ground via a tread surface, the two axial ends of which are connected via two sidewalls to two beads that provide the mechanical connection between the tyre and the rim on which it is intended to be mounted.

A radial tyre also comprises a reinforcement made up of a crown reinforcement radially on the inside of the tread and a carcass reinforcement radially on the inside of the crown reinforcement.

The carcass reinforcement of a radial tyre for a heavy vehicle of construction plant type usually comprises at least one carcass layer comprising generally metallic reinforcers coated in a polymeric material of the elastomer or elastomeric type known as a coating compound. A carcass layer comprises a main part that joins the two beads together and is generally wound, in each bead, from the inside of the tyre to the outside around a usually metallic circumferential reinforcing element known as a bead wire so as to form a turn-up. The metallic reinforcers of a carcass layer are substantially parallel to one another and form an angle of between 85° and 95° with the circumferential direction.

The crown reinforcement of a radial tyre for a heavy vehicle of construction plant type comprises a superposition of circumferentially extending crown layers radially on the outside of the carcass reinforcement. Each crown layer is made up of generally metallic reinforcers that are mutually parallel and coated in a polymeric material of the elastomer or coating compound type.

Among the crown layers, a distinction is usually made between the protective layers, which make up the protective reinforcement and are radially outermost, and the working layers, which make up the working reinforcement and are radially comprised between the protective reinforcement and the carcass reinforcement.

The protective reinforcement, comprising at least one protective layer, essentially protects the working layers from mechanical or physicochemical attack, likely to spread through the tread radially towards the inside of the tyre.

The protective reinforcement often comprises two protective layers, which are radially superposed, formed of elastic metallic reinforcers, are mutually parallel in each layer and crossed from one layer to the next, forming angles at least equal to 10° with the circumferential direction.

The working reinforcement, comprising at least two working layers, has the function of belting the tyre and conferring stiffness and road holding thereon. It absorbs both mechanical stresses of inflation, which are generated by the tyre inflation pressure and transmitted by the carcass reinforcement, and mechanical stresses caused by running, which are generated as the tyre runs over the ground and are transmitted by the tread. It is also intended to withstand oxidation and impacts and puncturing, by virtue of its intrinsic design and that of the protective reinforcement.

The working reinforcement usually comprises two working layers, which are radially superposed, formed of inextensible metallic reinforcers, are mutually parallel in each layer and crossed from one layer to the next, forming angles at least equal to 15° and at most equal to 60°, and preferably at least equal to 15° and at most equal to 45°, with the circumferential direction.

In order to reduce the mechanical stresses of inflation that are transmitted to the working reinforcement, it is known to dispose a hoop reinforcement radially on the inside of the working reinforcement and radially on the outside of the carcass reinforcement. The hoop reinforcement, the function of which is to at least partially absorb the mechanical stresses of inflation, improves the endurance of the crown reinforcement by stiffening the crown reinforcement. The hoop reinforcement can also be positioned radially between two working layers of the working reinforcement, or radially on the outside of the working reinforcement.

The hoop reinforcement comprises at least one hooping layer and usually two hooping layers, which are radially superposed, formed of metallic reinforcers, are mutually parallel, and form angles at most equal to 2.5°, and preferably around 0°, with the circumferential direction.

As regards the metallic reinforcers, a metallic reinforcer is characterized mechanically by a curve representing the tensile force (in N) applied to the metallic reinforcer as a function of the relative elongation (in %) thereof, known as the force-elongation curve. Mechanical tensile characteristics of the metallic reinforcer, such as the structural elongation As (in %), the total elongation at break At (in %), the force at break Fm (maximum load in N) and the breaking strength Rm (in MPa) are derived from this force-elongation curve, these characteristics being measured in accordance with the standard ISO 6892 of 1984.

The total elongation at break At of the metallic reinforcer is, by definition, the sum of the structural, elastic and plastic elongations thereof (At=As+Ae+Ap). The structural elongation As results from the relative positioning of the metallic threads making up the metallic reinforcer under a low tensile force. The elastic elongation Ae results from the actual elasticity of the metal of the metallic threads making up the metallic reinforcer, taken individually, the behaviour of the metal following Hooke's law. The plastic elongation Ap results from the plasticity, i.e. the irreversible deformation beyond the yield point, of the metal of these metallic threads taken individually. These different elongations and the respective meanings thereof, which are well known to a person skilled in the art, are described for example in the documents U.S. Pat. No. 5,843,583, WO2005/014925 and WO2007/090603.

Also defined, at any point on the force-elongation curve of a metallic reinforcer, is a tensile modulus, expressed in GPa, which represents the gradient of the straight line tangential to the force-elongation curve at this point. In particular, the tensile modulus of the elastic linear part of the force-elongation curve is referred to as the elastic tensile modulus or Young's modulus.

Among the metallic reinforcers, a distinction is usually made between the elastic metallic reinforcers, such as the ones used in the protective layers, and the inextensible metallic reinforcers, such as the ones used in the working layers.

An elastic metallic reinforcer is characterized by a structural elongation As at least equal to 1% and a total elongation at break At at least equal to 4%. Moreover, an elastic metallic reinforcer has an elastic tensile modulus at most equal to 150 GPa, and usually between 40 GPa and 150 GPa.

An inextensible metallic reinforcer is characterized by a total elongation At, under a tensile force equal to 10% of the force at break Fm, at most equal to 0.2%. Moreover, an inextensible metallic reinforcer has an elastic tensile modulus usually between 150 GPa and 200 GPa.

The document WO 2016139348 describes an architecture of a tyre for a heavy vehicle of construction plant type as described above and comprising a hoop reinforcement formed by a circumferential winding of a ply comprising circumferential elastic metallic reinforcers that make angles at most equal to 2.5° with the circumferential direction, said circumferential winding of the ply extending from a first circumferential end to a second circumferential end radially on the outside of the first circumferential end, so as to form a radial stack of at least two hooping layers, the hoop reinforcement being radially positioned between the two working layers of a working reinforcement.

The hoop reinforcement as described in that document is also characterized by reinforcers that have a force at break at least equal to 800 daN. Its axial width is less than half the axial width of the tyre.

During the manufacture of a tyre as described in the document WO 2016139348, the ply comprising elastic metallic reinforcers, known as ply of metallic reinforcers, which is intended to form the hoop reinforcement is initially stored on a roll. Then, it is unwound and laid by being circumferentially wound radially on the outside of the tyre layers already stacked radially. The ply of metallic reinforcers is wound over at least two turns so as to produce at least two hooping layers that are radially superposed, with a circumferential offset between the end at the start of winding and the end at the end of winding such that, over a limited circumferential distance, or covering length, the hoop reinforcement comprises three hooping layers. The winding is carried out continuously using a single portion of ply of metallic reinforcers. Thus, the hoop reinforcement does not contain any discontinuity. As a result, there may be a portion of ply of metallic reinforcers, on the initial storage roll, that is unusable since it is not long enough to produce the hoop reinforcement in one piece. This residual portion of ply of metallic reinforcers that is unusable for manufacturing because it is not long enough is also known as waste ply. The existence of such waste plies, which results in a loss of material, has a negative effect on the manufacturing cost of the tyre.

The inventors have set themselves the objective of reducing the manufacturing cost of a tyre for a heavy vehicle of construction plant type, and, in particular, that of the hoop reinforcement thereof, while ensuring the same endurance performance level of the crown thereof.

This objective has been achieved by a tyre for a heavy vehicle of construction plant type, comprising:
a crown reinforcement radially on the inside of a tread and radially on the outside of a carcass reinforcement;
the crown reinforcement comprising a protective reinforcement, a working reinforcement and a hoop reinforcement;
the protective reinforcement, which is radially outermost in the crown reinforcement, comprising at least one protective layer, the protective layer comprising metallic reinforcers that form an angle at least equal to 10° with a circumferential direction tangential to the circumference of the tyre;
the working reinforcement comprising at least two working layers, each working layer comprising metallic reinforcers that form an angle at least equal to 15° and at most equal to 45° with the circumferential direction and are crossed from one working layer to the next;
the hoop reinforcement being formed by a circumferential winding, in the circumferential direction, of a ply of metallic reinforcers extending from an initial radially inner end to a final radially outer end, forming a spiral, such that the hoop reinforcement comprises at least two hooping layers around the entire circumference and at least three hooping layers over an angular sector A, delimited by the initial and final ends, respectively, of the hoop reinforcement, the metallic reinforcers of the hoop reinforcement forming an angle at most equal to 2.5° with the circumferential direction;
the hoop reinforcement comprising at least one discontinuity positioned circumferentially between the initial end and final end, respectively,
and any discontinuity being positioned circumferentially, with respect to the initial or final end, forming an angle at least equal to 90°.

According to the invention, the hoop reinforcement comprises at least one discontinuity positioned circumferentially between the initial end and final end, respectively.

After a first complete turn of a ply of metallic reinforcers has been laid, waste plies can be used to complete the production of the hoop reinforcement. These waste plies are attached by bringing together the ends of the two portions to be joined. The space between these two ends is the discontinuity, which is filled with an elastomeric bonding compound which renders the two portions of ply of metallic reinforcers integral by welding. This is referred to as butt welding in that there is no overlap between the two portions of ply. In the prior art, it is known practice to weld the plies of metallic reinforcers along cuts parallel to the metallic reinforcers without severing the reinforcers. In the case of the invention, the metallic reinforcers intended to be laid circumferentially are severed, and for this purpose it is necessary to have a suitable cutting method that is capable of severing the metallic reinforcers that have a large diameter of typically around 3.8 mm. This cut should be sufficiently clean to avoid any contraction of the metallic threads making up the reinforcers, that is to say any spacing apart of the ends of the threads from one another. This contraction could create cracks in the elastomeric coating compound, either in a meridian plane or in a circumferential plane, likely to result in damage to the tyre.

Also according to the invention, any discontinuity is positioned circumferentially, with respect to the initial or final end, forming an angle at least equal to 90°.

In order to avoid any weakening of the tyre in terms of endurance, and in order to control the uniformity thereof, any discontinuity should be sufficiently far from the initial and final ends. This corresponds to a minimum circumferential distance equal to 2590 mm in the case of a laying radius of the hoop reinforcement equal to 1648 mm.

According to one embodiment variant of the invention, the hoop reinforcement comprises at least two discontinuities, which are circumferentially positioned between the initial end and final end, respectively, and form an angle at least equal to 90° between one another.

Again in order to avoid weakening the tyre in terms of endurance, and in order to control the uniformity thereof, the discontinuities should be sufficiently far from one another. The minimum angular offset between two discontinuities is at least equal to 90°, corresponding, for example, for a laying radius of the hoop reinforcement equal to 1648 mm, to a minimum circumferential distance between the discontinuities equal to 2590 mm.

The maximum number of waste plies that can be used depends on the circumference of the tyre and on the distance constraint between the discontinuities in the circumferential direction.

Advantageously, any discontinuity has a rectilinear mean line that forms an angle D strictly less than 90°, preferably at least equal to 15° and at most equal to 45°, and even more preferably at least equal to 25° and at most equal to 40°, with the circumferential direction.

The oblique orientation of the discontinuity with respect to the circumferential direction meets the need to avoid concentrating the ends of the severed metallic reinforcers in one and the same meridian plane. At the ends of the metallic reinforcers, the deformations of the elastomeric coating compound are at a maximum in terms of amplitude and can cause cracking in the meridian plane, resulting in separation of the working layers in the axial direction, and also cracking in the circumferential direction along the metallic reinforcers. For example, the discontinuity is oriented so as to make an angle of 30° with respect to the circumferential direction.

Geometrically, any discontinuity advantageously has a width at least equal to 10 mm and at most equal to 90 mm, preferably at most equal to 70 mm.

The portions of ply are joined by bringing together the two ends to be joined as far as a distance which represents the width of the weld. This width should be between 10 mm and 90 mm with a target value of 70 mm. Beyond a width equal to 90 mm, during manufacture, the weld may open during shaping phases which cause significant increases in the laying diameter of the hoop reinforcement.

As regards the material, any discontinuity is formed by an elastomeric filling material having a dynamic shear modulus G_{R}* at least equal to the dynamic shear modulus G_{E}* of the elastomeric coating material of the metallic reinforcers of the hoop reinforcement.

Any elastomeric filling material can be used as long as it is at least as rigid as the elastomeric coating material. Moreover, the elastomeric filling material should be compatible with the function of coating, for example have suitable properties of adhesion in the uncured state to the metallic reinforcers.

In a preferred embodiment of the material, any discontinuity is formed by an elastomeric filling material having a composition identical to that of the elastomeric coating material of the metallic reinforcers of the hoop reinforcement.

In order to optimize the cost of realizing the weld, the elastomeric filling material which renders the two ends of the portions of plies integral may be the elastomeric coating material.

As regards the circumferential distribution of the hoop reinforcement, the length of the angular sector A, delimited by the initial and final ends, respectively, of the hoop reinforcement, is advantageously at least equal to 0.6 m.

It is a matter here of defining the minimum length of overlap of the last hooping layer. This minimum length is deduced from the minimum value of the angular sector multiplied by the laying radius of the last layer. Specifically, the initial and final circumferential ends of the hoop reinforcement are not contained in one and the same meridian plane and overlap over a circumferential portion of the periphery of the tyre, in order to ensure that the hoop reinforcement is present around the entire periphery of the tyre. The circumferential distance between the two circumferential ends of the hoop reinforcement is known as the length of overlap. The length of overlap is understood to be the minimum circumferential distance between the circumferential ends of the hoop reinforcement, measured in the equatorial plane, the circumferential plane passing through the middle of the tread. The fact that the length of overlap is greater than 0.6 m makes it possible, firstly, to avoid a situation in which no zone of the tyre, under the effect of the change in diameter during curing, has one fewer layer of circumferential reinforcers between the working layers than the number of layers necessary for use, and, secondly, with each end of a reinforcer being a potential zone of cracking of the surrounding elastomeric materials, for these potential zones of cracking not to be concentrated in the same meridian plane, even at different radii.

Again as regards the circumferential distribution of the hoop reinforcement, the length of the angular sector A, delimited by the initial and final ends, respectively, of the hoop reinforcement, is at most equal to 1.2 m.

Limiting this length to 1.2 m makes it possible to limit the use of metallic ply to the bare minimum, and thus to limit the material cost without affecting endurance.

With another circumferential distribution of the hoop reinforcement, the length of the angular sector A, delimited by the initial and final ends, respectively, of the hoop reinforcement, is zero. This is an extreme case in which the initial and final ends, respectively, are positioned in one and the same meridian plane, i.e. without an overlap.

As regards the architecture of the crown reinforcement, the hoop reinforcement is advantageously radially comprised between two working layers of the working reinforcement.

Specifically, such an architecture makes it possible, by virtue of the use of circumferential reinforcers situated close to the neutral axis of the crown, to limit the deformation of the crown to the shoulders. This therefore makes it possible to obtain both the expected endurance performance with regard to cleavage of the crown and the intended impact resistance performance by virtue of a crown that is flexible at the centre and is able to tolerate the deformation due to impacts when the vehicle is driven over obstacles. Specifically, when passing over an obstacle, the crown of the tyre acts as a beam, the neutral axis of which is situated between the working layers depending on the type of deformation imposed. The neutral axis of bending of the crown reinforcement is situated between the stiffest crown layers, i.e.

between the working layers. By positioning the circumferential reinforcers between said working layers, the solution minimizes the stresses and bending deformations associated with this loading that the circumferential reinforcers should tolerate.

The metallic reinforcers of the hoop reinforcement are preferably elastic.

The shape factor at a given point of the hoop reinforcement is equal to the ratio of the radius R of said point on the shaped and vulcanized tyre to the radius R0 of the same point on the unshaped tyre, R and R0 being measured with respect to the axis of rotation of the tyre. By being positioned on the hoop reinforcement at the intersection with the equatorial plane, the ratio of relative variation of radii (R−R0)/R0 represents the maximum circumferential lengthening undergone by the metallic reinforcers on account of the manufacturing method.

During the shaping of the tyre, the elastic reinforcers lengthen in accordance with the shape factor applied and then take up their equilibrium position without any opening of the weld at the end of shaping. If the shape factors vary from 0.5% to 1%, the weld is robust and does not open.

Even more preferably, the metallic reinforcers of the hoop reinforcement are multistrand ropes of structure 1×N, comprising a single layer of N strands wound in a helix, each strand comprising an internal layer of M internal threads wound in a helix and an external layer of P external threads wound in a helix around the internal layer.

In a first embodiment of the multistrand ropes, N=3 or N=4, preferably N=4. Preferably, the reinforcer is defined with 4 strands, but the option with 3 strands is equally suitable.

In a second embodiment of the multistrand ropes, M=3, 4 or 5, preferably M=3.

In a third embodiment of the multistrand ropes, wherein P=7, 8, 9, 10 or 11, preferably P=8.

These reinforcers are designed so as to obtain significant elongation under low tensile loads. The preferred choice results in reinforcers of the type: 4×(3+8)×0.35, i.e. ropes with 44 threads with an individual diameter of each thread of 35 hundredths of a millimetre. The use of such reinforcers improves the endurance of the tyres by increasing the resistance to tensile stresses on passing over obstacles.

The use thereof may be extended to the protective layers, making it possible to tolerate local deformations imposed when driving over obstacles. By way of example, the multistrand ropes of the type 4×(3+8)×0.35, i.e. ropes with 44 threads with an individual diameter of each thread of 35 hundredths of a millimetre. These reinforcers have a diameter at least equal to 3 mm and a force at break at least equal to 800 daN. The high value of the diameter makes it possible to absorb the deformations in shear of the protective layer over a greater thickness, this generating lower shear stresses. The high value of the force at break allows the reinforcer to tolerate higher breaking stresses, thereby improving the performance of the crown in terms of endurance with regard to impacts. Finally, the elasticity of these reinforcers during the manufacturing phase favours the expansion of the laying diameter resulting from the curing of the tyres in a mould.

The use of the same reinforcers for the hoop and protective reinforcements relates to a rationale of standardizing the constituents of the tyre that is favourable for lowering the manufacturing costs without impairing the performance of the product and the performance of the method.

As regards the protective reinforcement, the metallic reinforcers of the protective layer form an angle at least equal to 15° and at most equal to 40° with the circumferential direction.

The protective reinforcement usually comprises two protective layers, the respective metallic reinforcers of which are crossed from one protective layer to the next.

A further subject of the invention is a method for manufacturing a tyre as described above, and, more specifically, the step of producing the hoop reinforcement thereof.

The method for manufacturing a tyre for a heavy vehicle of construction plant type according to the invention comprises a step of producing the hoop reinforcement, in which the hoop reinforcement is obtained by circumferentially winding in a spiral at least two portions of a ply of metallic reinforcers, made up of mutually parallel metallic reinforcers coated in an elastomeric coating material, and by butt welding the adjacent ends of two successive ply portions, each butt weld forming a discontinuity formed by an elastomeric filling material.

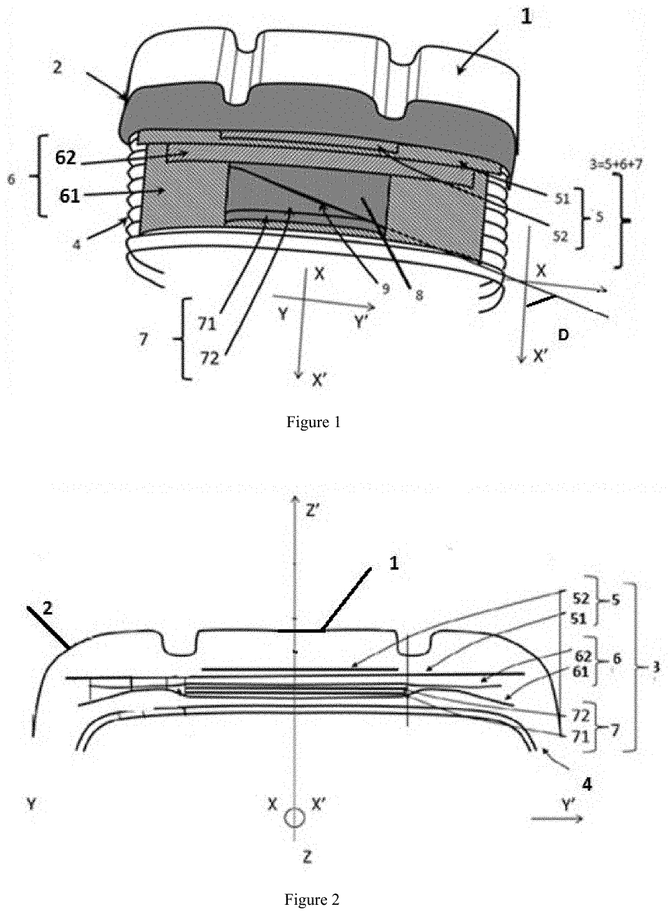

The invention is illustrated in FIGS. 1 to 7, which are not depicted to scale in order to make them easier to understand:

FIG. 1 shows a cutaway perspective view of the crown of a tyre 1 according to the prior art, having:
a tread 2 radially on the outside of a carcass reinforcement 4,
the crown reinforcement 3 comprising a protective reinforcement 5, a working reinforcement 6 and a hoop reinforcement 7,
the protective reinforcement 5, which is radially outermost in the crown reinforcement 3, comprising two protective layers (51, 52), each protective layer (51, 52) comprising metallic reinforcers that form an angle at least equal to 10° with a circumferential direction (XX′) tangential to the circumference of the tyre,
the working reinforcement 6 comprising two working layers (61, 62), each working layer (61, 62) comprising metallic reinforcers that form an angle at least equal to 15° and at most equal to 45° with the circumferential direction (XX′) and are crossed from one working layer to the next,
the hoop reinforcement 7 being formed by a circumferential winding, in the circumferential direction (XX′), of a ply of metallic reinforcers 8 extending from an initial radially inner end 81 to a final radially outer end 82, forming a spiral, such that the hoop reinforcement 7 comprises at least two hooping layers (71, 72).

FIG. 2 shows a meridian section through the crown of a tyre 1 according to the invention, having:
a tread 2;
a carcass reinforcement 4;
a crown reinforcement 3 comprising a working reinforcement 5 comprising two working layers 51 and 52, a hoop reinforcement 7 comprising a winding of two turns of circumferential reinforcers 71 and 72, and a protective reinforcement 6 comprising two protective layers 61 and 62.

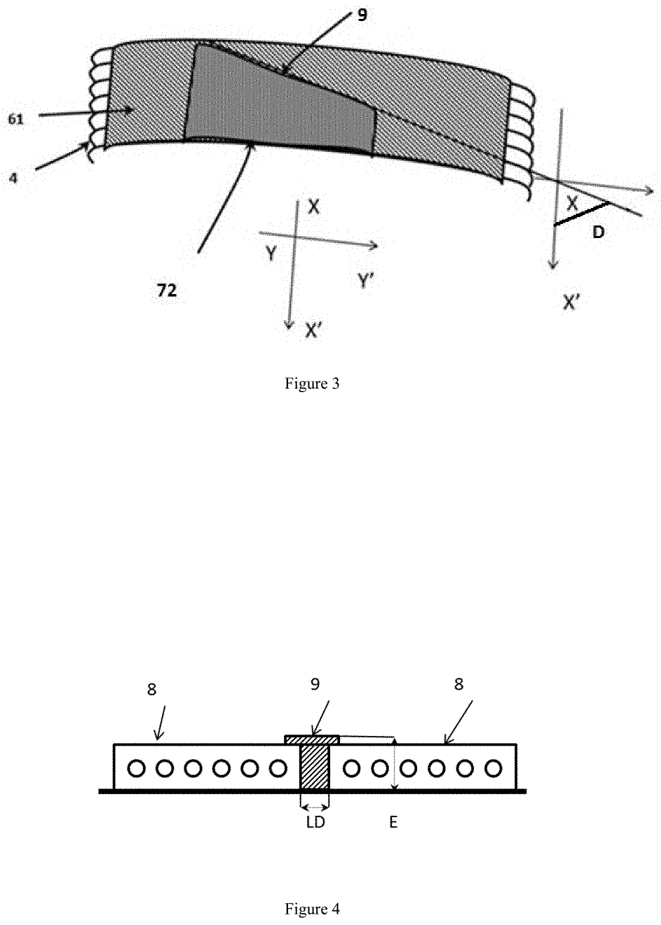

FIG. 3 shows a discontinuity 9 of the hooping layer 72, the mean line of which forms an angle D with the circumferential direction XX′. The hooping layer 72 is radially on the outside of the working layer 61, which is itself radially on the outside of the carcass reinforcement 4.

FIG. 4 shows the connection of the discontinuity 9 between two portions of plies of metallic reinforcers 8. This connection, realized by an elastomeric coating material, is characterized by its width LD at least equal to 10 mm and at most equal to 90 mm, and by its thickness E, which is at least equal to that of the ply of metallic reinforcers.

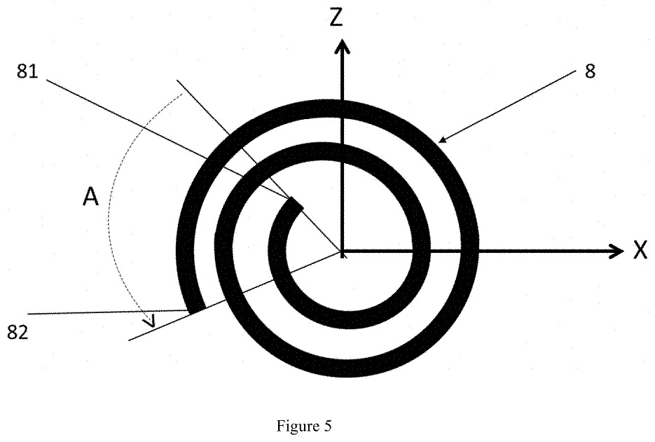

FIG. 5 shows the schematic diagram of the manufacture of the hoop reinforcement by winding in a spiral a ply of metallic reinforcers 8, which starts from an end 81, continues through a second turn, and then over an angular sector A in which three hooping layers (71, 72, 73) are superposed. The winding ends at an end 82.

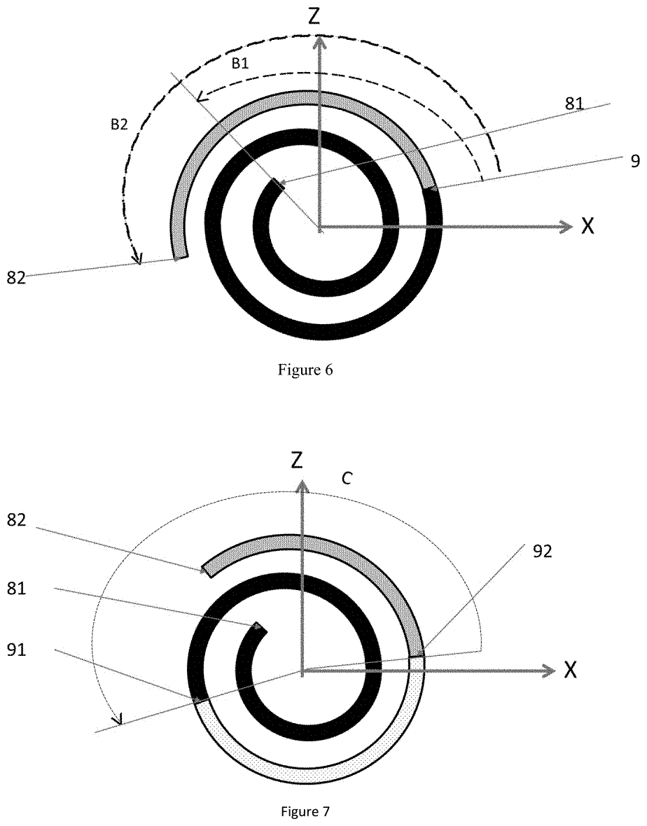

FIG. 6 shows the invention with a second hooping layer comprising a discontinuity 9 resulting from the incorporation of a waste ply of metallic reinforcers in the second winding turn. The discontinuity 9 forms an angle B1 with the initial end 81 and forms an angle B2 with the final end 82.

FIG. 7 differs from FIG. 6 by the elimination of the overlap and by the incorporation of two waste plies of metallic reinforcers in the second winding turn. The two resulting discontinuities 91 and 92 form an angle C at least equal to 90° with one another.

The invention was carried out on a tyre for a heavy vehicle of construction plant type of size 40.00R57. The tyre according to the invention differs from the prior art tyre by the realization of the hoop reinforcement. Whereas the prior art tyre was obtained by continuous winding of the hoop through two turns, for the invention, hooping was carried out by winding a succession of portions of layers joined together by a butt connection.

The result presented in Table 1 below corresponds to the difference in cost of the hoop reinforcement of the two tyre variants:

TABLE 1

| | Prior art: | Invention: | | |
|---|---|---|---|---|
| | spiral hoop | Variant which | | |
| | reinforcement | includes butt | | |
| | laid in two | welds in the | | |
| | continuous | production | Differ- | |
| | turns without | of the hoop | ence | |
| | discontinuity | reinforcement | (%) | Comments |
| Hoop | 91 | 86 | 5% | The superposition |
| rein- | | | | of the weld over |
| forcement | | | | a length of 1 m |
| (kg) | | | | causes a 5% |
| | | | | increase in mass |
| | | | | of the hoop |
| | | | | reinforcement |

By eliminating the overlaps of the hooping layers, during the production of the butt welds, the saving in material cost is estimated to be 5%.

1.-16. (canceled)

17. A tire for a heavy vehicle of construction plant type, the tire comprising:
a crown reinforcement radially on the inside of a tread and radially on the outside of a carcass reinforcement, the crown reinforcement comprising a protective reinforcement, a working reinforcement, and a hoop reinforcement,
the protective reinforcement, which is radially outermost in the crown reinforcement, comprising at least one protective layer, the protective layer comprising metallic reinforcers that form an angle at least equal to 10° with a circumferential direction XX′ tangential to the circumference of the tire,
the working reinforcement comprising at least two working layers, each working layer comprising metallic reinforcers that form an angle at least equal to 15° and at most equal to 45° with the circumferential direction XX′ and are crossed from one working layer to the next, and
the hoop reinforcement being formed by a circumferential winding, in the circumferential direction XX′, of a ply of metallic reinforcers extending from an initial radially inner end to a final radially outer end, forming a spiral, such that the hoop reinforcement comprises at least two hooping layers around the entire circumference and at least three hooping layers over an angular sector A, delimited by the initial and final ends, respectively, of the hoop reinforcement, the metallic reinforcers of the hoop reinforcement forming an angle at most equal to 2.5° with the circumferential direction XX′,
wherein the hoop reinforcement comprises at least one discontinuity positioned circumferentially between the initial end and the final end, respectively, and any discontinuity is positioned circumferentially, with respect to the initial end or the final end, forming an angle at least equal to 90°.

18. The tire according to claim 17, wherein the hoop reinforcement comprises at least two discontinuities, which are circumferentially positioned between the initial end and the final end, respectively, and form an angle C at least equal to 90° between one another.

19. The tire according to claim 17, wherein any discontinuity has a rectilinear mean line that forms an angle D strictly less than 90° with the circumferential direction XX′.

20. The tire according to claim 19, wherein any discontinuity has a rectilinear mean line that forms an angle D at least equal to 15° and at most equal to 45° with the circumferential direction XX′.

21. The tire according to claim 20, wherein any discontinuity has a rectilinear mean line that forms an angle D at least equal to 25° and at most equal to 40° with the circumferential direction XX′.

22. The tire according to claim 17, wherein any discontinuity has a width LD at least equal to 10 mm and at most equal to 90 mm.

23. The tire according to claim 22, wherein any discontinuity has a width LD at most equal to 70 mm.

24. The tire according to claim 17, wherein any discontinuity is formed by an elastomeric filling material having a dynamic shear modulus G_{R}* at least equal to the dynamic shear modulus G_{E}* of the elastomeric coating material of the metallic reinforcers of the hoop reinforcement.

25. The tire according to claim 17, wherein any discontinuity is formed by an elastomeric filling material having a composition identical to that of the elastomeric coating material of the metallic reinforcers of the hoop reinforcement.

26. The tire according to claim 17, wherein the length of the angular sector A delimited by the initial and final ends, respectively, of the hoop reinforcement is at least equal to 0.6 m.

27. The tire according to claim 17, wherein the length of the angular sector A delimited by the initial and final ends, respectively, of the hoop reinforcement is at most equal to 1.2 m.

28. The tire according to claim 17, wherein the length of the angular sector A delimited by the initial and final ends, respectively, of the hoop reinforcement is zero.

29. The tire according to claim 17, wherein the hoop reinforcement is radially comprised between two working layers of the working reinforcement.

30. The tire according to claim 17, wherein the metallic reinforcers of the hoop reinforcement are elastic.

31. The tire according to claim 30, wherein the metallic reinforcers of the hoop reinforcement are multistrand ropes of structure 1×N comprising a single layer of N strands wound in a helix, each strand comprising an internal layer of M internal threads wound in a helix and an external layer of P external threads wound in a helix around the internal layer.

32. The tire according to claim 31, wherein N=3 or N=4.

33. The tire according to claim 31, wherein M=3, 4 or 5.

34. The tire according to claim 31, wherein P=7, 8, 9, 10 or 11.

35. A method of manufacturing the tire according to claim 17 comprising:
a step of producing the hoop reinforcement, in which the hoop reinforcement is obtained by circumferentially winding in a spiral at least two portions of a ply of metallic reinforcers, made up of mutually parallel metallic reinforcers coated in an elastomeric coating material, and by butt welding the adjacent ends of two successive ply portions, each butt weld forming a discontinuity formed by an elastomeric filling material.
